(19) United States
(12) Patent Application Publication
(10) Pub. No.: US 2005/0230183 A1
(43) Pub. Date: Oct. 20, 2005

(54) Tangle resistant safety harness

(76) Inventor: C. Marty Sharp, Glendale, AZ (US)

Correspondence Address: REED SMITH CROSBY HEAFEY LLP, 1901 AVENUE OF THE STARS, SUITE 700, LOS ANGELES, CA, 90067, US

(21) Appl. No.: 10/826,069

(22) Filed: Apr. 16, 2004

(51) Int. Cl. A62B 1/16; A47L 3/04; E06C 7/18; A63B 29/02; A62B 35/00; B60R 22/00; B60R 22/12

(52) U.S. Cl. 182/3

(57) ABSTRACT

An improved strap for the construction of safety harnesses of the type designed to protect against falls provides increased flexibility and comfort. The strap is composed of a tubular sheath of elastic fabric that coaxially surrounds a typical high strength safety strap. The two components of the strap are sized so that the safety strap is longer than the surrounding tubular elastic sheath. This causes the longitudinal compression and thickening of the safety strap which then acts as filler to form a “pillow” from the sheath. This cushions the strap making it more comfortable while the longitudinal compression of the enclosed safety strap increases its flexibility. During a fall the sheath rapidly stretches and the enclosed safety strap elongates to full length to stop the fall in the normal manner of safety straps.

### BACKGROUND OF THE INVENTION

1. Area of the Art

The present invention concerns safety devices intended to prevent dangerous falls and more particularly safety harnesses to be worn when working in high places to protect the wearer from an accidental fall.

2. Description of the Prior Art

Safety harnesses are commonly used as part of a fall protection system for persons who must work at heights. In the workplace full-body safety harnesses are often required. Such harnesses, which typically include shoulder straps, can be designed in many alternative manners. U.S. Pat. No. 5,329,884, to Bell discloses a popular harness design with a pair of leg straps, a pair of upper torso straps, a pair of rappelling straps, a seat strap, and four belt suspenders wherein the torso straps include chest strap and back strap portions. A similar design is U.S. Pat. No. 5,531,292, also to Bell.

Typical of this type of harness is a design in which the torso straps are formed as left and right front “suspender” straps run from a belt strap, up the left and right side, respectively, of a wearer and over the wearer's shoulders like typical suspenders. The straps then “crisscross” at the center of the wearer's back by passing through a crossover connector. The original left strap then attaches to the belt strap on the right back side of the user's waist while the original right strap attaches to the belt strap on the left back side of the user's waste. Thus, there are really two torso straps that crossover. One torso strap comprises the left front and right back “suspender” strap while the other strap comprises the right front and left back “suspender” strap. The straps pass through the base o a D-ring at the crossover connector. The D-ring is attached to a long anchor strap that prevents the wearer from striking the ground should he or she fall.

This basic design has proven successful as it is relatively simple and yet provides a high level of safety since it is almost impossible for the wearer to slip out of the harness. However, the design is not without some problems. Basically, many people find it fairly difficult to thread and unthread straps that form a complex structure. That is, a wearer prefers to slip into and out of a harness with a minimal need to fasten and unfasten straps. Because the design just described allows a wearer to don or remove the harness by simply unfastening the leg straps, the design accommodates the desire to slip the harness on and off. However, when the harness is doffed, it tends to transform into a formless tangle which may require considerable straightening before the wearer is again able to don it.

This problem was to some extent addressed by Bell (U.S. Pat. No. 5,329,884) who added a small strap 514 near to the crossover of the embodiment pictured in his FIG. 8. The primary stated purpose of this small strap is to promote the vertical orientation of the straps. U.S. Pat. No. 6,253,874 to Casebolt has improved upon the small strap 514 by incorporating it into a plastic crossover connector that maintains the torso straps in the proper crisscross orientation. However, the Casebolt crossover connector is necessarily limited in size and may not be able to maximally prevent tangling.

### BRIEF DESCRIPTION OF THE FIGURES

FIG. 1 shows a diagrammatic view of the back of a safety harness employing the anti-tangling device of the present invention;

FIG. 2 shows a front view of the anti-tangling device of the harness of FIG. 1.

### DETAILED DESCRIPTION OF THE PRESENT INVENTION

The present invention has been described to enable any person of ordinary skill to prevent tangling of straps in a “crisscrossed” safety harness by connecting the two rear crossed straps with a special resilient strap-like member.

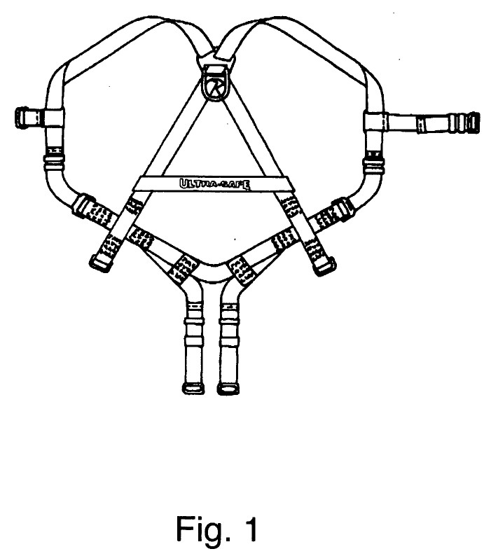

FIG. 1 shows a typical crossover safety harness 10 with front suspender straps 12, 14 and rear suspender straps 16, 18. The right front suspender strap 12 actually connects to the left rear suspender strap 18 because the straps criss-cross at a crossover 20. The crossover 20 is stabilized by a buckle-like connector 22. A D-ring 18 is attached to the connector 22 and/or threaded onto the straps at or near the crossover 18.

One dons the harness 10 by inserting ones right arm through a right loop 28 and ones left arm through a left loop 30. A right chest strap 24 is connected to a left chest strap 28 and a right leg strap 32 encircles the right leg to connect to a right receiving strap 34, and a left leg strap 36 encircles the left leg to connect to a left receiving strap 38. An anti-tangling strap 40 connects the left and right suspender straps 14, 16 at a position between the crossover 20 and the rear seat strap 42. The anti-tangling strap 40 is preferably located about 12 inches below the crossover 20 for a harness designed for an average sized (about 5 foot ten inches) height male. The length of the anti-tangling strap 40 is about 12 inches for the average sized harness. Compared to prior art straps used to connect rear suspender straps the anti-tangling strap 40 is somewhat longer and hence located at a somewhat greater distance from the crossover.

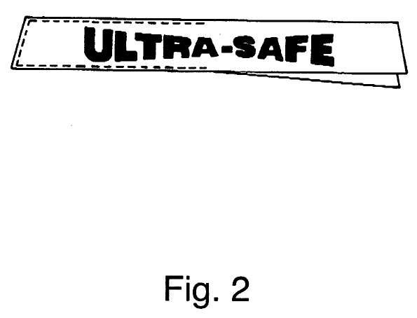

The anti-tangling strap 40 is connected to the straps by any convenient means such as sewing or adhesives although other connection devices such as snaps or hook in loop fasteners can be used. Ideally, the anti-tangling strap 40 is attached to the rear suspender straps 16, 18 in a permanent manner or at least a manner that does not allow the anti-tangling strap 40 to readily move relative to the crossover 20. It is important that the anti-tangling strap 40 be significantly stiffer than the normal strap material of the harness 10. While the anti-tangling strap 40 is somewhat bendable in a direction essentially normal to the plane of the strap, the anti-tangling strap 40 is structured to be extremely difficult to deform in a direction parallel to the plane of the strap and normal to the long axis of the strap. One way of constructing an anti-tangling strap 40 is shown in FIG. 2 where the anti-tangling strap 40 is constructed by laminating two plies 44, 46 of strap material. In the figure the lamination is achieved by stitching around the perimeter of the strap 40 although adhesive can be used either with or without stitching. Alternatively, the anti-tangling strap 40 can fabricated from a length of plastic having the desired characteristics.

The strap 40 is sufficiently stiff to maintain the rear suspender straps 16, 18 in a spaced apart position to inhibit tangling and yet be somewhat flexible in a direction normal to the strap's 40 plane so that it may adapt to the curvature of the wearer's back. It will be apparent to one of skill in the art that an optimal distance from the crossover 20 is important for the invention to function properly. If the distance of the anti-tangling strap 40 from the crossover 20 is too small-say six inches or less for an average size harness-even a totally inflexible strap will not be able to hold the rear suspender straps 16, 18 far enough apart to optimally avoid tangling. Yet such a small inflexible strap will be uncomfortable to the wearer because it does not conform to the back. If the anti-tangling strap 40 is positioned too far from the crossover 20—say 18 inches or greater for an average sized harness-the strap 40 will become less effective because a strap having optimum flexibility for a 12 inch strap will be too floppy and flexible for an 18 inch strap. Yet even such a strap may be uncomfortable at is runs around the wearer's seat. If the strap stiffness is increased to decrease tangling, it will become prohibitively uncomfortable. Thus, the optimal distance from the crossover 20 expressed as the length of a line drawn normal to the long axis of the anti-tangling strap 40 and intersecting the crossover 20 is from about eight inches to about 16 inches for an average sized harness. This distance should be scaled appropriately for very small or very large harnesses.

Prior to the present invention the advantage of connecting the rear suspender straps 16, 18 of a safety harness with a strap of optimum length and flexibility was not recognized. The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

1. An improved safety harness of the type where left and right front suspender straps pass through a crossover to become right and left rear suspender straps, respectively, and whose ends are joined by a seat strap, wherein the improvement comprises an anti-tangling strap joining the left and rear suspender straps disposed between the crossover and the seat strap and forming a triangle wherein the crossover is at the apex of the triangle and a height of the triangle is greater than about eight.

2. The improved safety harness of claim 1, wherein the height of the triangle is less than about sixteen inches.

3. The improved safety harness of claim 1, wherein the anti-tangling strap is formed by laminating two plies of strap material.

4. The improved safety harness of claim 3, wherein the anti-tangling strap is laminated by stitching and/or adhesive.

5. The improved safety harness of claim 1, wherein the anti-tangling strap is formed from a flexible plastic material.

6. The improved safety harness of claim 1, wherein the anti-tangling strap is stiffer than the suspender straps but is elastically flexible in a direction normal to the plane of the anti-tangling strap.

7. The improved safety harness of claim 6, wherein the anti-tangling strap cannot be readily flexed in a direction parallel to the plane of the anti-tangling strap and normal to the long axis of the anti-tangling strap.

8. A wearable safety harness comprising:
left and right front suspender straps;
right and left rear suspender straps connected respectively to the left and right front suspender straps by a crossover;
a seat strap joining distal ends of said rear suspender straps; and
an anti-tangling strap joining the left and rear suspender straps disposed between the crossover and the seat strap and forming a triangle wherein the crossover is at the apex of the triangle and a height of the triangle is between about eight and about sixteen inches.
